(19) United States
(12) Patent Application Publication
(10) Pub. No.: US 2007/0291733 A1
(43) Pub. Date: Dec. 20, 2007

(54) Integration of Packet and Cellular Telephone Networks

(75) Inventors: Eran Doran, Tel Aviv (IL); Ofer Salomon, Kfar Hanagid (IL); Ronny Aruch, Petah Tikva (IL); Boaz Goldman, Moshav Shoeva (IL)

Correspondence Address: WELSH & KATZ, LTD, 120 S RIVERSIDE PLAZA, 22ND FLOOR, CHICAGO, IL, 60606, US

(73) Assignee: OUTSMART LTD., Lod (IL)

(21) Appl. No.: 10/591,216

(22) PCT Filed:
(86) PCT No.: PCT/IL05/00256

Related U.S. Application Data
(60) Provisional application No. 60/550,747, filed on Mar. 4, 2004.

(51) Int. Cl. H04L 12/66

(52) U.S. Cl. 370/352

(57) ABSTRACT

Communication apparatus (22) includes a packet network interface (62), for coupling to a packet switch (28) in a packet network (24), and a telephone network interface (63), for coupling to a node (54) in a circuit-switched telephone network (26). A convergence processor (66) is coupled between the packet network and telephone network interfaces and adapted to emulate a mobile switching center (MSC) and a visitor location register (VLR) in the circuit-switched telephone network so as to assign telephone numbers in the circuit-switched telephone network to user terminals (30, 32, 34, 38) in the packet network and to connect telephone calls, using the assigned telephone numbers, between telephones (42) in the circuit-switched network and the user terminals. 51617

### CROSS-REFERENCE TO RELATED APPLICATION

This application claims the benefit of U.S. Provisional Patent Application 60/550,747, filed Mar. 4, 2004, which is incorporated herein by reference.

### FIELD OF THE INVENTION

The present invention relates generally to communication networks, and specifically to convergence of packet telephony with cellular and other circuit-switched telephone networks.

### BACKGROUND OF THE INVENTION

Packet telephony systems, particularly Voice over Internet Protocol (VoIP), are rapidly gaining in popularity. VoIP permits packet telephone calls to be placed between IP terminals, which are identified by IP addresses rather than telephone numbers. The Session Initiation Protocol (SIP) is generally used for call signaling, while the media (audio data) are carried between the terminals by Real Time Protocol (RTP) packets.

Calls between IP terminals and telephones in circuit-switched networks (such as cellular and wireline telephone networks) may be placed via suitable VoIP gateways. The VoIP gateway typically converts SIP packets to Signaling System 7 (SS7) messages and RTP packets to pulse-code modulated (PCM) audio signals, and vice versa. For example, U.S Patent Application Publication US 2003/0076815 A1, whose disclosure is incorporated herein by reference, describes a VoIP architecture in which a signaling gateway provides transparent inter-operation between the VoIP network and the public switched telephone network (PSTN) by translating messages between the networks. Other methods for connecting VoIP and SS7 networks are described in U.S. Pat. Nos. 6,075,783, 6,324,183 and 6,683,881, whose disclosures are also incorporated herein by reference.

Dual-function telephones, which are capable of communicating over both the packet and circuit-switched networks, are also known in the art. For example, U.S. Pat. No. 6,614,786 describes an enhanced dual-mode telephone for Internet telephony. The telephone has a mode control switch, which is either manually selectable to permit a user to choose between making a call over a standard telephone network or over the Internet, or is automatically controlled to route the call via the more advantageous communications link. Another telephone of this sort, allowing access to both the telephone network and a computer communication network, is described in U.S. Patent Application Publication US 2002/0114430 A1.

### SUMMARY OF THE INVENTION

Embodiments of the present invention provide apparatus and methods for integrating packet telephones into a circuit-switched network, such as a cellular telephone network. This integration is made possible by a convergence gateway, which couples the packet telephone network to the circuit-switched network. The gateway emulates the function of a switch, such as a mobile switching center (MSC), in the circuit-switched network, so that the connection between the networks is transparent to the existing infrastructure of the circuit-switched network.

Telephones on the packet network may thus be assigned conventional telephone numbers in the circuit-switched network, with the convergence gateway serving as the visitor location register (VLR) for these numbers. Subscribers in the circuit-switched network can then place calls to telephones in the packet network simply by dialing the number. The calls are routed by the switches in the circuit-switched network to the MSC/VLR function of the convergence gateway, which maps the telephone numbers to the appropriate packet network addresses and converts the call signaling and media from SS7/PCM to the appropriate packet network protocols, such as SIP/RTP. The gateway performs the reverse processes when subscribers in the packet network place calls to telephone numbers in the circuit-switched network. This arrangement also permits packet network subscribers to use (and be billed for) the services of the circuit-switched network.

Although embodiments of the present invention are described hereinbelow with specific reference to convergence of fixed IP telephony networks with cellular (mobile) networks, the principles of the present invention may similarly be applied to integration of other types of packet networks—including both fixed and mobile users—with circuit-switched networks, as well as to integration of packet telephone networks with wired circuit-switched networks, such as the PSTN.

There is therefore provided, in accordance with an embodiment of the present invention, communication apparatus, including:

a packet network interface, for coupling to a packet switch in a packet network;

a telephone network interface, for coupling to a node in a circuit-switched telephone network; and

a convergence processor, coupled between the packet network and telephone network interfaces and adapted to emulate a mobile switching center (MSC) and a visitor location register (VLR) in the circuit-switched telephone network so as to assign telephone numbers in the circuit-switched telephone network to user terminals in the packet network and to connect telephone calls, using the assigned telephone numbers, between telephones in the circuit-switched network and the user terminals.

In disclosed embodiments, the packet network includes an Internet Protocol (IP) network, and the telephone network includes a cellular telephone network. In one embodiment, the convergence processor is adapted to assign different, first and second telephone numbers to a given user terminal in the packet network, wherein the first telephone number belongs to the cellular telephone network, and the second telephone number belongs to a public switched telephone network (PSTN). Additionally or alternatively, the convergence processor is adapted to assign to the user terminals telephone numbers having a first country code, while the user terminals are located in a country having a different, second country code.

Typically, the packet network interface includes a session border controller, which is operative to perform Network Address Translation (NAT), and the telephone network interface includes a media gateway. Additionally or alternatively, the apparatus includes a softswitch, which is coupled between the packet network and telephone network interfaces and the convergence processor so as to convey instructions from the convergence processor to the packet network and telephone network interfaces regarding handling of the telephone calls to and from the user terminals. In a disclosed embodiment, the softswitch is adapted to communicate with the packet network and telephone network interfaces by transmitting and receiving at least one of Session Initiation Protocol (SIP) and SIP for telephones (SIP-T) packets.

In some embodiments, the convergence processor is adapted to receive registration requests from the user terminals and, in response to the registration requests, to register the user terminals in a home location register (HLR) in the telephone network. In a disclosed embodiment, the convergence processor is adapted to communicate with the HLR in order to determine respective service profiles applicable to the user terminals and, responsively to the service profile, to invoke an Intelligent Network (IN) service in the telephone network that is to be applied to a call. Optionally, the convergence processor is adapted to determine the respective service profiles initially upon registration of the user terminals and to update one or more of the service profiles thereafter while the user terminals are in operation. typically, the convergence processor is adapted to receive from the packet network interface an indication of a request from one of the user terminals to set up a call, and responsively to the indication, to cause the telephone network interface to route the call to a telephone number in the telephone network in accordance with an applicable service profile.

Additionally or alternatively, the convergence processor is adapted to receive a request from the HLR for routing information with respect to a call placed from the telephone network to a telephone number that is assigned to a user terminal having a network address in the packet network and, responsively to the request, to cause the packet network interface to route the call to the network address of the user terminal.

In a disclosed embodiment, the convergence processor is adapted to communicate with the HLR using a Mobile Application Protocol (MAP).

There is also provided, in accordance with an embodiment of the present invention, a method for communication, including:

coupling a convergence processor between a packet switch in a packet network and a node in a circuit-switched telephone network;

assigning telephone numbers in the circuit-switched telephone network to user terminals in the packet network; and

connecting telephone calls, using the assigned telephone numbers, between telephones in the circuit-switched network and the user terminals, by operating the convergence processor so as to emulate a mobile switching center (MSC) and a visitor location register (VLR) of the assigned numbers in the circuit-switched telephone network.

The present invention will be more fully understood from the following detailed description of the embodiments thereof, taken together with the drawings in which:

### BRIEF DESCRIPTION OF THE DRAWINGS

FIG. 1 is a block diagram that schematically illustrates an integrated telephone communication network system, in accordance with an embodiment of the present invention;

FIGS. 2A and 2B are block diagrams that schematically shows details of a fixed-mobile convergence (FMC) gateway, in accordance with an embodiment of the present invention;

FIG. 3 is a flow chart that schematically illustrates a method for handling a telephone call placed from an IP network to a mobile network, in accordance with an embodiment of the present invention;

FIG. 4 is a flow chart that schematically illustrates a method for handling a telephone call placed from a mobile network to an IP network, in accordance with an embodiment of the present invention;

FIG. 5 is a communication flow diagram that schematically illustrates a process of registration of an IP telephone with a FMC gateway, in accordance with an embodiment of the present invention;

FIG. 6 is a communication flow diagram that schematically shows messaging associated with a telephone call placed from an IP network to a mobile network, in accordance with an embodiment of the present invention; and

FIG. 7 is a communication flow diagram that schematically shows messaging associated with a telephone call placed from a mobile network to an IP network, in accordance with an embodiment of the present invention.

### DETAILED DESCRIPTION OF EMBODIMENTS

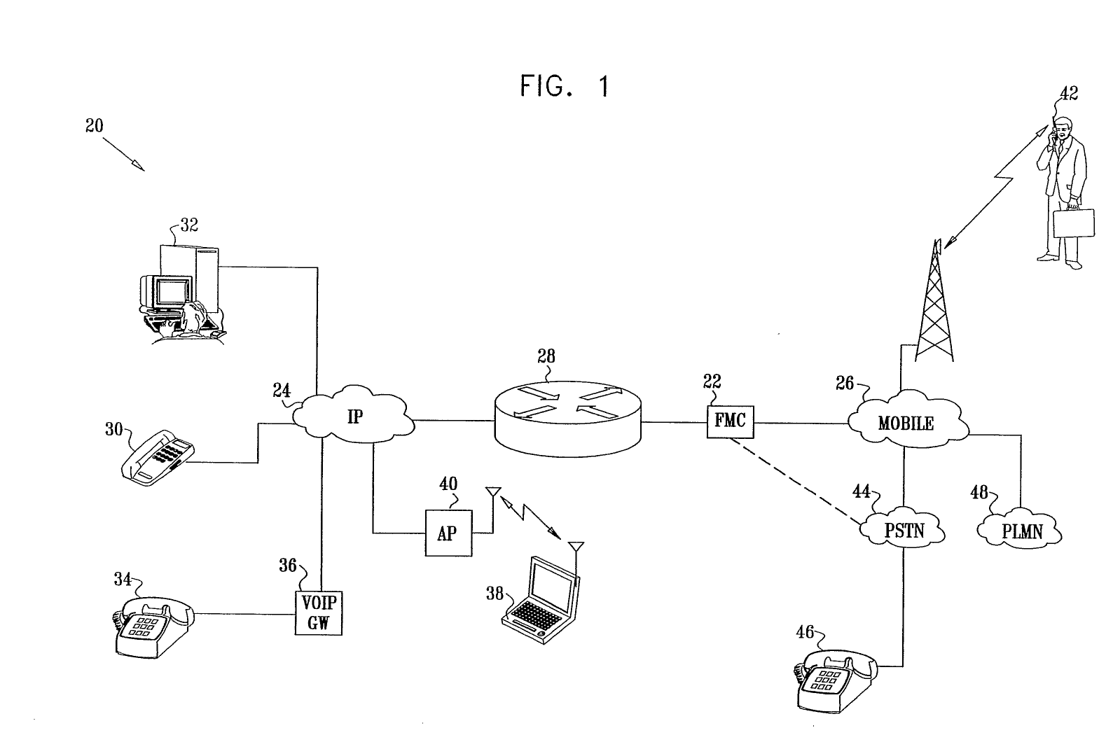

FIG. 1 is a block diagram that schematically illustrates an integrated telephone communication system 20, in accordance with an embodiment of the present invention. System 20 comprises heterogeneous networks linked by a fixed-mobile convergence (FMC) gateway 22. In the present embodiment, gateway 22 links an IP packet network 24 with a cellular mobile network 26. Gateway 22 is connected to the packet network via a router 28, as is known in the art. The packet network may be the public Internet, or it may alternatively be a private network, such as an enterprise or campus network.

FMC gateway 22 permits user terminals on packet network 24 to place calls to and receive calls from mobile network 26. For this purpose, the terminals on the packet number are assigned telephone numbers in mobile network 26. (Alternatively or additionally, the user terminals in packet network 24 may receive telephone numbers in a wireline telephone network, such as a PSTN 44, to which gateway 22 is linked.) Any suitable type of user terminal on packet network 24 may be used to place and receive calls. Several examples are shown in FIG. 1: an IP telephone 30; a personal computer 32 with audio (and possibly video) interface; an analog telephone 34 connected to a VoIP gateway 36 or VoIP adapter; and a wireless computing device 38, which communicates with packet network 24 via an access point 40. The user terminals in packet network 24 communicate with FMC gateway 22 using standard VoIP protocols, such as SIP and RTP. Typically, the SIP client program on the user terminals is configured with the IP address of gateway 22 as the SIP proxy address, so that all VoIP traffic from the user terminals is directed to the gateway. Although the embodiments described herein refer specifically to certain protocols, such as SIP and RTP, the principles of the present invention may similarly be applied in environments using other VoIP protocols known in the art, such as H.323.

The telephone number assigned to each user terminal in network 24 is typically a mobile station international subscriber digital number (MSISDN), which is recorded by gateway 22 and mapped by the gateway to the IP address of the user terminal in question. There is no need for the telephone numbers to correspond to the actual geographical locations of the user terminals. Thus, a user terminal that is located in one geographical area may be assigned an area code in a different geographical area or even in a different country. Furthermore, a single user terminal may be assigned multiple telephone numbers, such as numbers with different country codes for dialing to and from different countries, or numbers in both mobile network 26 and in PSTN 44. Additionally or alternatively, the user terminals in network 24 may be identified by addresses similar to e-mail addresses.

If packet network 24 comprises a private network, then FMC gateway 22 may be configured to provide private branch exchange (PBX) telephone service to the user terminals on the network.

With respect to mobile network 26, FMC gateway 22 emulates the operation of a mobile switching center (MSC), and emulates the function of the visitor location register (VLR) (which is typically, although not necessarily, associated with the MSC). The telephone numbers that are assigned to the user terminals on packet network 24 are recorded in the emulated VLR. This emulation function is described in greater detail hereinbelow. It permits telephones 42 in mobile network 26 to place calls transparently to, selected user terminals in packet network 24, simply by dialing the assigned number. The user terminals in packet network 24 may similarly place calls through FMC gateway 22 to the telephones in the mobile network. The FMC gateway is responsible, with respect to the user terminals, for all the essential functions of a conventional MSC in mobile network 26, such as registration, authentication and call routing, as well as location updating and handovers. (The handover function is relevant particularly for dual-function mobile telephones, which have both cellular and wireless LAN interfaces and may thus place and receive calls through access point 40.)

Furthermore, because FMC gateway 22 appears to network 26 to be simply another MSC, the user terminals in packet network 24 may also place and receive calls through the gateway to and from other networks that are connected to network 26, such as PSTN 44 and other public land mobile networks (PLMN) 48. The connection to these other networks may be via mobile network 26 or, alternatively, by direct connection between the FMC gateway and the other networks. Gateway 22 thus carries calls to and from wireline telephones 46, as well as mobile telephones.

Although embodiments of the present invention are described, for the sake of convenience, using terminology taken from the vocabulary of GSM cellular networks, the principles of the present invention are equally applicable to other types of mobile networks, such as CDMA networks.

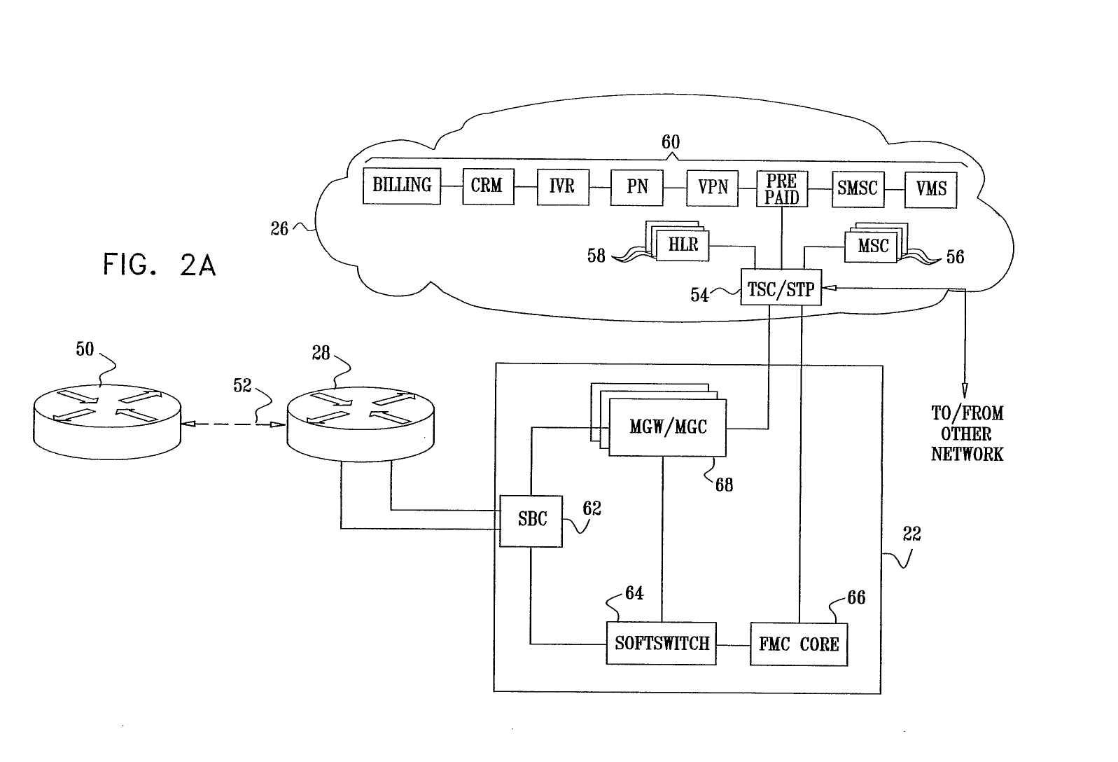

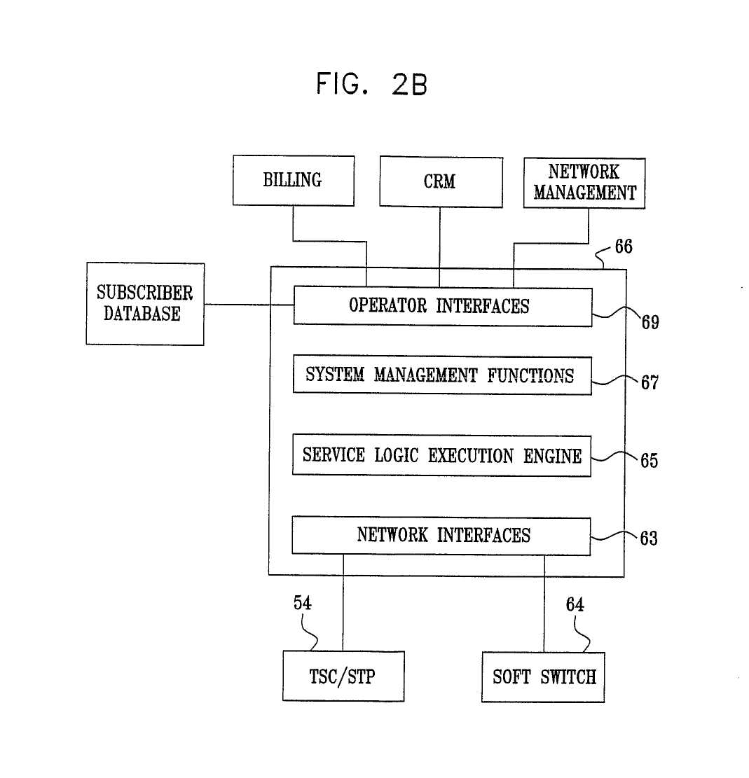

FIG. 2A is a block diagram that schematically shows details of FMC gateway 22, in accordance with an embodiment of the present invention. The operation of the functional elements of the FMC gateway in handling specific types of calls is illustrated in the figures that follow. Although these functional elements are shown in the figure as separate units for the sake of conceptual clarity, in practice certain of the functions may be integrated in a single physical unit, or divided among multiple physical units. FIG. 2A also illustrates connections between components of gateway 22 and elements of networks 24 and 26.

Gateway 22 interfaces to the packet network through a session border controller (SBC) 62, which connects to router 28 at the edge of the packet network. This router is typically connected to a core switch 50 or to multiple switches in the packet network via a suitable access medium 52. A key function of SBC 62 is to enable VoIP protocols, such as SIP, to traverse Network Address Translation (NAT) at IP network borders. NAT converts internal private IP addresses inside an organization to external public IP addresses. Thus, the source IP address appearing in SIP packets received by gateway 22 (i.e., the public IP address) from a user terminal on packet network 24 may be different from the actual internal IP address of the terminal. SBC 62 therefore performs its own address translation on the public IP address in order to identify the user terminal. In this context, the SBC also handles conflicts that may arise when identical private IP addresses are used in different organizations.

Other functions of SBC 62 may include:
Security-related functions, such as access control permission and interaction with firewalls.
Signaling/media limiting, which limits the number of requests sent by a specific terminal in order to prevent overload or erratic performance.
Call routing (specifically DNS [Domain Name System]-based routing) and load balancing in packet network 24.
Load balancing among the other elements of gateway 22.
Lawful interception enablement, for recording the RTP stream of calls passing through the gateway.
Holding and forwarding location information for emergency services (E911).

SBC 62 passes SIP signaling to and from an internal softswitch 64. This softswitch is a SIP server, which interacts with SIP-based terminals and applications on packet network 24. Softswitch 64 may also be programmed to perform the functions of SBC 62. All SIP requests that originate from or are directed to a user terminal on the packet network pass through softswitch 64. These requests generally include registration messages, call setup and teardown messages (such as SIP INVITE and BYE messages), notification messages and other messages mandated by SIP. The SIP messages are typically handled by a B2BUA (Back to Back User Agent) application, which runs on softswitch 64 under the control of an FMC core processor 66. The B2BUA notifies the FMC core processor of relevant events and acts on instructions received from the FMC core processor. For example, the FMC core processor typically controls subscriber-forwarding functionality, and instructs the softswitch to generate SIP messages according to the desired forwarding behavior. The functions of the FMC core processor are described further hereinbelow.

A media gateway (MGW)/media gateway controller (MGC) 68 converts call signaling between SIP and SS7 protocols and converts the media between RTP and PCM formats. (Typically, FMC gateway 22 comprises a bank of media gateways/controllers, which share the load of signaling and media conversion.) During the course of a call between packet network 24 and mobile network 26, SBC 62 passes the signaling (SIP) packets to softswitcl 64, which instructs the MGC to convert and forward the signaling to the appropriate entity in network 26, as well as converting signaling in network 26 to SIP form for transfer to softswitch 64. Typically, the SIP-T protocol is used in communicating between the softswitch and the MGC, while the MGC communicates with MSCs 56 in network 26 using the ISDN User Part (ISUP) SS7 protocol. (SIP-T refers to “SIP for telephones,” which maps SIP functions to ISUP interconnection requirements, as described in Request for Comments (RFC) 3372 of the Internet Engineering Task Force (IETF).) Although the MGC is shown in the figure as integrated with the MGW, the MGC function may alternatively reside in softswitch 64.

The MGC is also responsible for controlling and managing the resources of one or more MGWs. The functions of the MGC include, for example, call control logic, media port selection, and media compression selection. Typically, the MGC controls the MGW using protocols known in the art, such as the Media Gateway Control Protocol (MGCP) or MEGACO. The MGW terminates the audio signals in voice calls, which arrive from network 26 in PCM form, and converts them into RTP packets for transmission over packet network 24, using a codec supported by RTP to compress the voice signals. For voice calls originating from network 24, the MGW performs these functions in reverse order. The MGW may also perform additional functions, such as detection and generation of dual-tone multi-frequency (DTMF) signals, telephone conferencing, interactive voice response (IVR), announcements, and other functions known in the art. MGW/MGC 68, and likewise SBC 62 and softswitch 64, may comprise off-shelf products, which are configured and programmed to carry out the functions described herein. The functions of the MGC may optionally be integrated into softswitch 64.

FMC core processor 66 (referred to hereinbelow for the sake of brevity as the FMC core) manages the processes and services performed by the other elements of gateway 22. The FMC core is also responsible for handling connectivity to mobile network 26 via a suitable node in the cellular network, typically a switching point 54, such as a transit switching center (TSC) or signaling transfer point (STP). The FMC core receives call requests from packet network 24 through softswitch 64 and from mobile network 26 through switching point 54, and manages the corresponding call session in network 26 by emulating the functions of a MSC in network 26. In addition, the FMC core serves as a VLR for the various subscribers in network 24. For this purpose, the FMC core maintains a database listing the correspondence between IP addresses in network 26 and the corresponding telephone numbers in network 24. In the capacity of MSC/VLR, the FMC core also performs registration and deregistration, as described hereinbelow, in order to attach and detach SIP users and update their locations in mobile network 26. In the course of registration, the FMC core communicates with HLR 58 in order to receive the subscriber profile. The profile may also be updated following the initial registration. The FMC core uses standard SS7 protocols, such as the Mobile Application Protocol (MAP) or IS-41, to communicate with HLR 58 and other MSCs 56 in network 26.

FMC core 66 also participates in supplementary service interactions with HLR, such as activation, modification and deactivation of call forward features. In the case of multi-mode user terminals (with both cellular and packet capabilities, such wireless LAN-enabled cellular telephones), the FMC core manages handovers of the terminals between VoIP and cellular service. Furthermore, by interacting with HLR 58 and other elements in network, the FMC core enables the operator of mobile network 26 to provide value-added services 60, including Intelligent Network (IN) services, to subscribers on packet network 24. These services include, for example, IVR-based services, personal number (PN) service, virtual private networks (VPN), pre-paid calling. Subscribers in packet network 24 receive these services by having an appropriate originating and/or terminating IN category key (OICK or TICK or other types of service key) in the HLR in which their corresponding telephone numbers in mobile network 26 are recorded. FMC core 66 generates appropriate call detail records (CDRs) for calls to and from these subscribers for purposes of billing and customer relations management (CRM).

FIG. 2B is a block diagram showing further functional details of FMC gateway 22, and specifically of FMC core 66, in accordance with an embodiment of the present invention. The FMC gateway typically comprises standard, off-shelf hardware components, which are programmed in software to carry out the functions described herein. For example, the softswitch, FMC core 66 and associated elements of the FMC gateway may comprise HS20 or HS40 Xeon™ server blades (IBM Corp., Armonk, N.Y.), or other suitable off-shelf hardware components, with network interfaces 63 for communicating with networks 24 and 26. Typically, the hardware comprises redundant components for the sake of reliability.

FMC core 66 comprises the following key functional components:
Network interface functions, preformed by network interfaces 63, including support for a range of telephony and application protocols. Support network protocols typically include SS7 over E1, SIGTRAN over IP, and UDP/SCTP/TCP over IP.
A Service Logic Execution Engine (SLEE) 65 executes procedures triggered by inputs from the networks, and thus controls calls and events.
System Management Functions (SMF) 67 perform activities such as configuration management, fault management and performance management. The SMF contains an internal database for operational configuration information, including system deployment configuration and service logic/application definitions.
Operator Interface Functions (OIF) 69 manage the interfaces to operator platforms. These interfaces include, for example, system configuration, performance monitoring, fault monitoring, subscriber provisioning and subscriber charging, which are typically implemented over suitable packet protocols, such as HTTP, SNMP and FTP.

Optionally, FMC core 66 may include a “presence” module, which enables subscribers in network 24 to update their current status (for example, available or busy) and maintain body-lists. The FMC gateway uses this information in order to perform call routing based on subscriber availability. For example, if a subscriber changes his availability status to “busy,” his telephone number is automatically changed to “not reachable,” and calls will be redirected to his forwarding number. As another example, when a subscriber has two contacts, i.e., two endpoints where he can be reached, the presence module can be directed to indicate the endpoint to which calls should be redirected.

Although FMC gateway 22 is shown in the figures as a single unit, its functions may alternatively be distributed among multiple sites, connected by a high-speed packet network for inter-site coordination. The database maintained by FMC core 66 may be replicated at multiple sites, so that the gateway system will continue operating even in the event of a failure at one of the sites.

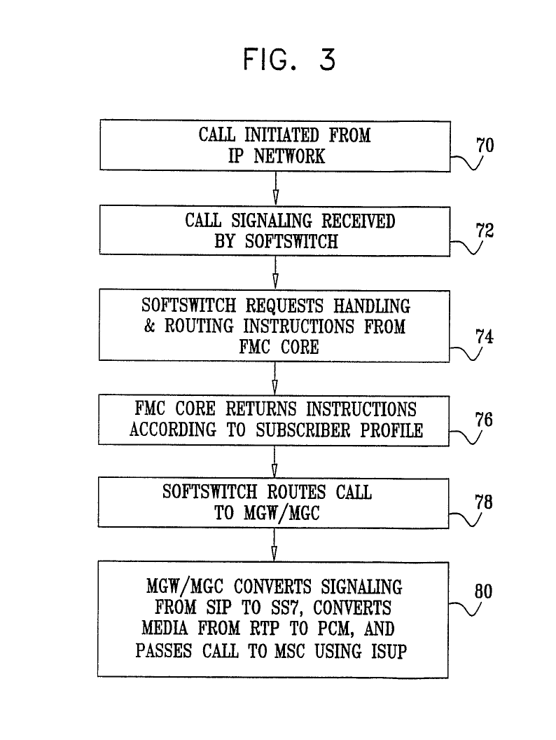

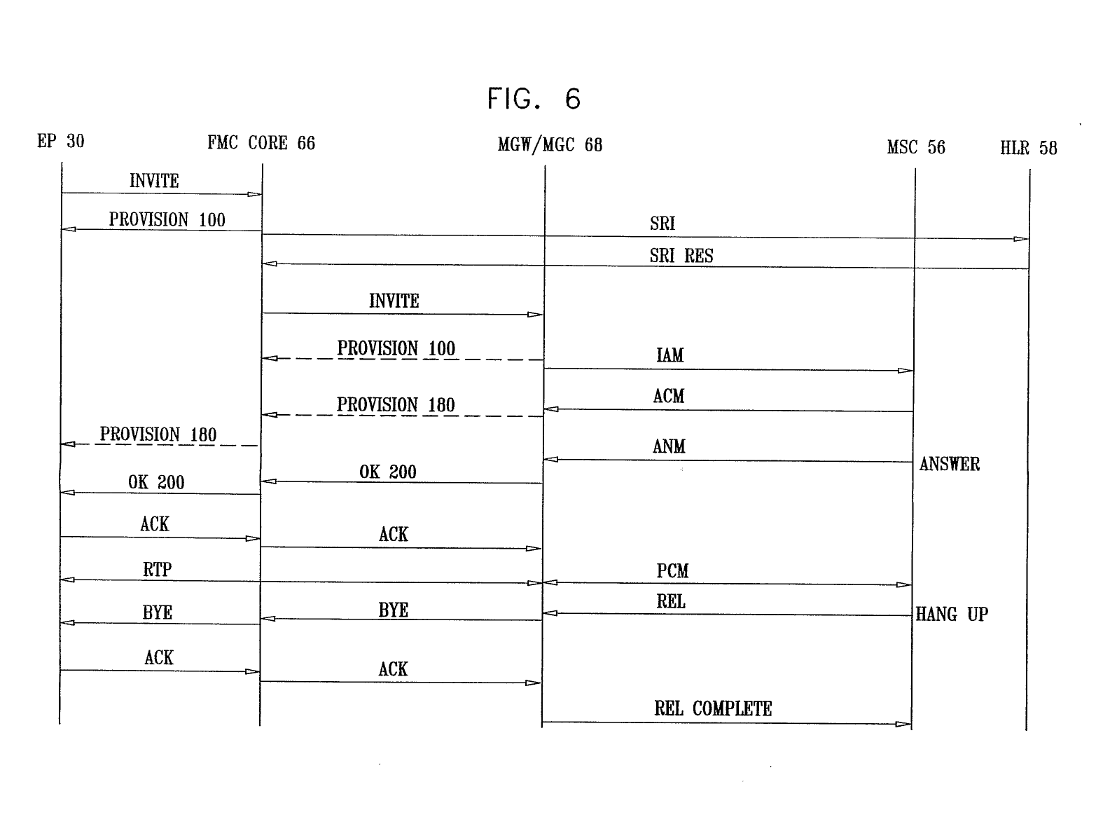

FIG. 3 is a flow chart that schematically illustrates a method by which FMC gateway 22 handles a call placed from an IP telephone in packet network 24 to a destination telephone in mobile network 26, in accordance with an embodiment of the present invention. A typical messaging scenario associated with this method is shown in FIG. 6 and described hereinbelow. For the sake of the current example, it is assumed that IP phone 30 previously registered with FMC gateway 22, as described hereinbelow, so that the gateway has a record of the telephone number and IP address of phone 30. At the time of registration, the FMC gateway typically requests information regarding this subscriber from HLR 58, and then stores the information in its own database.

IP phone 30 initiates the call by sending a SIP request packet to gateway 22, at a call initiation step 70. The SIP packet is received by SBC 62, which forwards the packet to softswitch 64, at a signaling forwarding step 72. The softswitch determines that a new connection is to be established with a destination telephone, and requests instructions from FMC core 66, at an instruction request step 74. The FMC core looks up the subscriber profile of this subscriber in its database. The FMC core may also query HLR 58 to check the TICK listed for the destination telephone number, in order to determine IN services 60 that may be applicable to the call. Based on the subscriber profile (and possibly the TICK), the FMC core returns call handling and routing instructions to softswitch 64, at an instruction conveyance step 76.

In response to the instructions from the FMC core, softswitch 64 routes the call to MGW/MGC 68, at an internal routing step 78. In other words, the softswitch passes SIP signaling messages arriving from IP phone 30 to the MGW/MGC, which converts the messages to the corresponding SS7 messages, at a message conversion step 80. Similarly, the softswitch passes RTP packets to the MGW/MGC, which converts the packets to PCM digital audio signals. The MGW/MGC passes the SS7 messages and media to switching point 54, using ISUP. The switching point conveys the messages and media to the appropriate MSC 56 in mobile network 26 (or to the appropriate switches in other networks, if the call destination is outside network 26). The remainder of the call is handled via the MGW/MGC (with participation by FMC core 66 and softswitch 64), until the call is terminated. Termination of the call by either of the parties generates corresponding ISUP Release and SIP Bye messages.

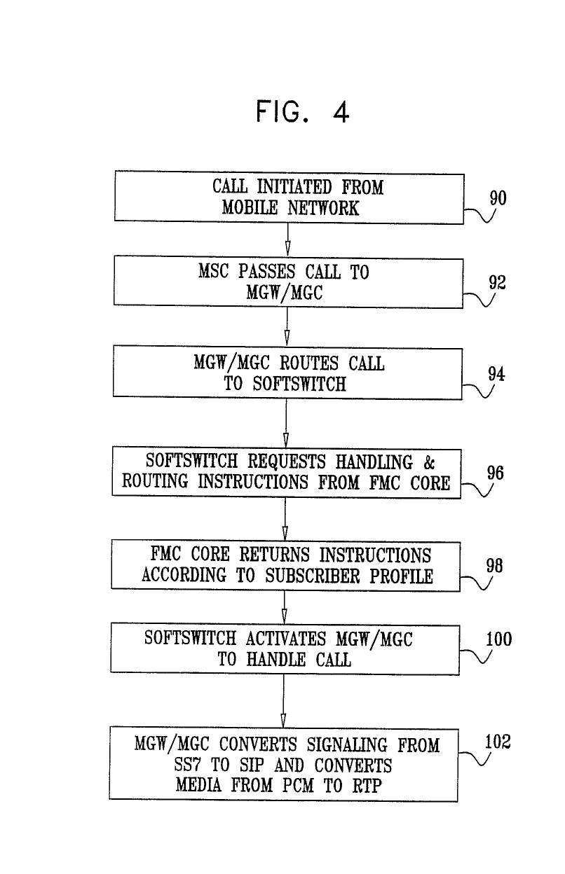

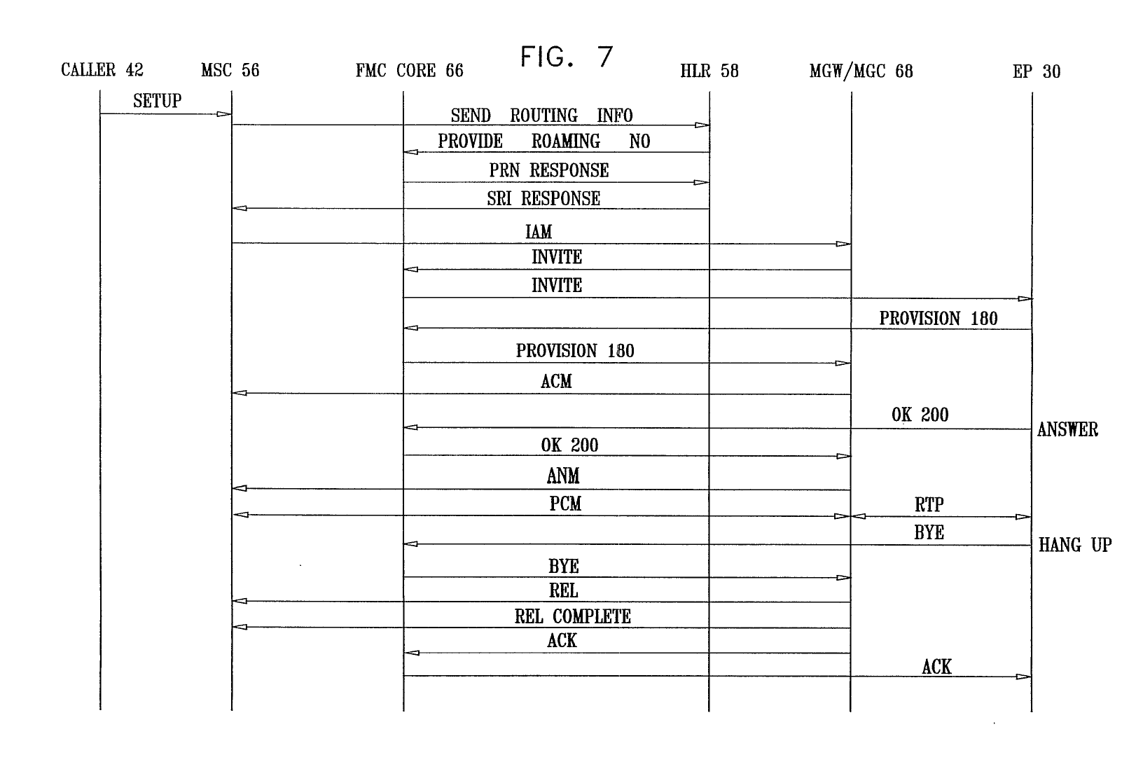

FIG. 4 is a flow chart that schematically illustrates a method by which FMC gateway 22 handles a call placed from a telephone in mobile network 26 to a destination telephone in packet network 24, in accordance with an embodiment of the present invention. A typical messaging scenario associated with this method is shown in FIG. 7 and described hereinbelow. In this example, it is assumed that telephone 42 initiates the call by signaling the appropriate MSC 56, at a call initiation step 90. The signaling indicates the destination telephone number of a user terminal in network 26, such as the telephone number assigned to IP phone 30. FMC core 66 has already registered in HLR 58 as the VLR for this destination telephone number. Therefore, when MSC 56 queries the HLR for routing information with respect to the destination telephone number, the HLR refers the MSC to FMC gateway 22 as the serving MSC for this number. Consequently, MSC 56 passes the call signaling (in SS7/ISUP form) via switching point 54 to gateway 22, at a call signaling step 92.

MGW/MGC 68 receives the signals from MSC 56, converts the signals to their SIP equivalent, and passes the corresponding SIP messages to softswitch 64, at an internal routing step 94. The softswitch requests handling and routing instructions for the call from FMC core 66, at an instruction request step 96. The FMC core looks up the destination telephone number in its database in order to determine the appropriate IP destination address for the call. Typically, the FMC core also checks the subscriber profile for the destination telephone number to determine whether special service or billing instructions apply to the call. Similarly to the case of outgoing calls, MSC 56 may communicate with HLR 58 to look up the subscriber's TICK number and check whether any IN services 60 are to be applied.

The FMC core then returns appropriate routing and handling instructions to softswitch 64, at an instruction conveyance step 98. The instructions indicate the destination IP address of IP phone 30. The softswitch activates MGW/MGC 68 to handle the call packets to and from this IP address, at a gateway activation step 100. The MGW/MGC subsequently converts SS7 messages from MSC 56 to SIP and converts PCM media to RTP, as described above, and conveys the signaling and media packets to IP phone 30, at a signal conversion step 102. The remainder of the call is handled by the MGW/MGC (with participation by FMC core 66 and softswitch 64), until the call is terminated. As in the case of outgoing calls, termination of the call by either of the parties generates corresponding ISUP Release and SIP Bye messages.

### Exemplary Messaging Scenarios

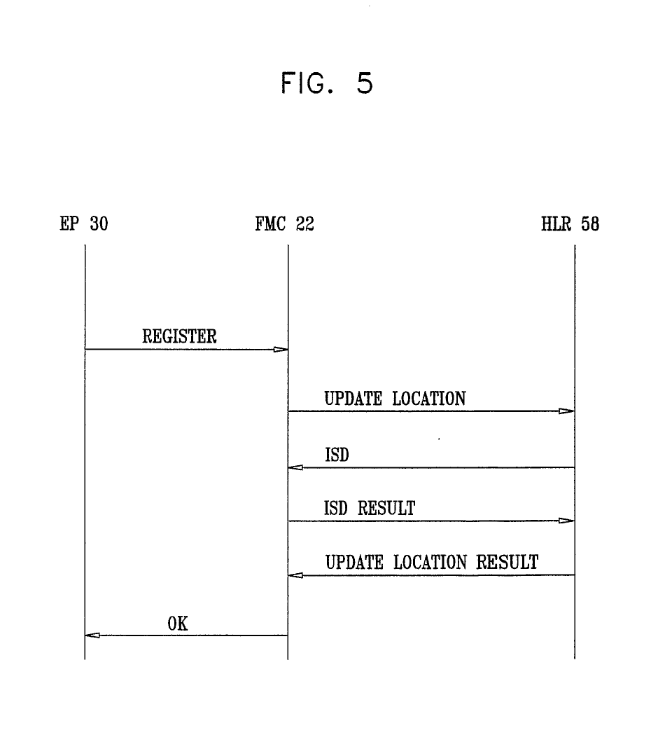

FIG. 5 is a communication flow diagram, which schematically illustrates a process by which FMC gateway 22 registers subscribers in packet network 24 for telephone service in mobile network 26, in accordance with an embodiment of the present invention. In this and subsequent examples, IP phone 30 is used as an example of an end-point (EP) in the IP network. When a terminal in network 24 comes on line, it registers itself with FMC core 66 by sending a SIP packet to gateway 22 indicating its MSISDN and IP address. The SIP packet includes a username and password, which are used by the FMC core in authenticating the subscriber's identity. Any suitable authentication method can be used for this purpose, such as the MD5 authentication algorithm.

Upon authenticating the subscriber, FMC core 66 sends an Update Location message to HLR 58 to indicate to the HLR that the subscriber is registered and on line. This message tells the HLR that FMC gateway 22 is the VLR for the subscriber's assigned telephone number. In response, the FMC core receives an Insert Subscriber Data (ISD) message from the HLR giving the subscriber profile (OICK, along with other information) for use in handling subsequent calls. The FMC core acknowledges receipt of the ISD message by sending an ISD Result message to the HLR, which responds with an Update Location Result message when the process is finished. The FMC core then sends an acknowledgment of successful registration to the user terminal (IP phone 30 in this example).

The initial registration packet from the user terminal is also used by SBC 62 in resolving the IP address of the terminal for purposes of NAT. The process of registration of the subscriber with FMC gateway 22 may be repeated periodically, for example every 30 seconds, in order to keep the NAT connection open for purposes of calls to the user terminal from other telephones and terminals.

The telephone service to the user terminal can be terminated either by the terminal itself or by HLR 58. In the former case, the terminal simply sends a deregistration message to FMC gateway 22, with an indication to the FMC core to deregister the subscriber. The deregistration message is typically authenticated in the same manner as the registration message, as described above. Upon receiving the deregistration message, FMC core 66 sends a PurgeMS message to HLR 58, instructing the HLR to erase the registration of the subscriber's telephone number, so that the FMC core is no longer listed as the VLR for this number. The HLR records that the subscriber is no longer on line, and sends an acknowledgment to the FMC core.

Alternatively, the HLR may terminate the registration by sending the VLR part of a Cancel Location message to the FMC core. When the HLR resets, it sends a message to FMC core 66 indicating that all the VLR registrations have been erased. Subsequently, whenever one of the subscribers submits a registration request, the FMC core will go through the entire process of location update to renew the registration of the subscriber in the HLR.

If mobile network 26 comprises multiple HLRs, it may be necessary for FMC core 66 to register different subscribers in different HLRs. Before sending an Update Location message to one of the HLRs, the FMC core refers the request to the Flexible Number Routing (FNR) function of the TSC, as is known in the art. The FNR function identifies the HLR for the telephone number in question and routes the message accordingly. The response to the Update Location request that is subsequently received by the FMC core contains the address of the HLR in which the telephone number is actually recorded, thus enabling the FMC core to route subsequent messages directly to the proper HLR.

FIG. 6 is a communication flow diagram that schematically shows messaging associated with a telephone call placed from a user terminal, such as IP phone 30, to a telephone in mobile network 26, in accordance with an embodiment of the present invention. General aspects of this process were described above with reference to FIG. 3. As noted there, IP phone 30 initiates the call by sending a SIP INVITE request to FMC gateway 22, which responds with a SIP 100 message (“Trying”). FMC core 66 sends a Send Routing Information (SRI) message to HLR 58, which the HLR answers with a SRI response. Based on this information, the FMC core 66 instructs softswitch 64 to send a SIP INVITE message to MGW/MGC 68. In response to this SIP message, the MGW/MGC sends an Initial Address Message (IAM) to MSC 56, which answers with an Address Complete Message (ACM), followed by an Answer Message (ANM) when the call recipient (telephone 42, for example) picks up the telephone. The MGW/MGC responds by sending the appropriate SIP messages (180—“RINGING” and 200—“OK”) via softswitch 64 to IP phone 30.

Once the call has been established, the parties exchange voice data via MGW/MGC 68, which converts RTP to PCM, and vice versa. When one of the parties to the call (IP phone 30 or telephone 42) hangs up, the appropriate Release (REL) messages are exchanged between MGW/MGC 68 and MSC 56, with a corresponding SIP BYE message sent between MGW/MGC 68 and IP phone 30. (In the scenario shown in FIG. 6, it is assumed that the telephone in network 26 hands up first, but the reverse order is equally possible.) FIG. 7 is a communication flow diagram that schematically shows messaging associated with a telephone call placed from telephone 42 in cellular network 26 to IP phone 30 in packet network 24, in accordance with an embodiment of the present invention. In this case, the call begins with a setup message from telephone 42 to MSC 56. The MSC sends a SRI message to HLR 58 with respect to the destination number of the call. The HLR looks up the VLR of the destination number, determines that the VLR is FMC core 66, and sends a Provide Roaming Number (PRN) request to the FMC core. The FMC core sends a PRN response to the HLR, indicating that calls to the destination number in question should be routed to MGW/MGC 68. The HLR passes this information to MSC 56 in a SRI Response message.

MSC 56 now sends an IAM message to MGW/MGC 68. In response to this message, the MGW/MGC exchanges SIP messages with IP phone 30 via softswitch 64 in order to establish the call. The MGW/MGC sends ACM and ANM messages to MSC 56 as the call setup progresses, as shown in the figure. (Messages sent between MSC 56 and telephone 42 are omitted from the figure for the sake of simplicity.) The call is subsequently proceeds and is then terminated as in the scenario of FIG. 6.

FMC gateway 22 may also be used as a VoIP server in calls between different IP terminals in packet network 24, or between different packet networks. In this case, MGW/MGC 68 has no role to play in the call itself, and the call is set up and torn down by conventional SIP signaling. By virtue of the operation of FMC core 66, however, the parties are able to place the call using their telephone numbers in cellular network 26. Furthermore, in setting up and servicing the call, FMC core 66 requests and receives service information from HLR 58 for purposes of billing and provision of IN services 60 as appropriate.

Although the embodiments described above relate specifically to voice services, the principles of the present invention may similarly be applied in transmitting other types of media, such as video. As another example, FMC gateway 22 may be adapted to carry text messages, such as Short Message Service (SMS) messages, between subscribers in networks 24 and 26.

It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. Communication apparatus, comprising:
a packet network interface, for coupling to a packet switch in a packet network;
a telephone network interface, for coupling to a node in a circuit-switched telephone network; and
a convergence processor, coupled between the packet network and telephone network interfaces and adapted to emulate a mobile switching center (MSC) and a visitor location register (VLR) in the circuit-switched telephone network so as to assign telephone numbers in the circuit-switched telephone network to user terminals in the packet network and to connect telephone calls, using the assigned telephone numbers, between telephones in the circuit-switched network and the user terminals.

2. The apparatus according to claim 1, wherein the packet network comprises an Internet Protocol (IP) network, and wherein the telephone network comprises a cellular telephone network.

3. The apparatus according to claim 2, wherein the convergence processor is adapted to assign different, first and second telephone numbers to a given user terminal in the packet network, wherein the first telephone number belongs to the cellular telephone network, and the second telephone number belongs to a public switched telephone network (PSTN).

4. The apparatus according to claim 1, wherein the convergence processor is adapted to assign to the user terminals telephone numbers having a first country code, while the user terminals are located in a country having a different, second country code.

5. The apparatus according to claim 1, wherein the packet network interface comprises a session border controller, which is operative to perform Network Address Translation (NAT).

6. The apparatus according to claim 1, wherein the telephone network interface comprises a media gateway.

7. The apparatus according to claim 1, and comprising a softswitch, which is coupled between the packet network and telephone network interfaces and the convergence processor so as to convey instructions from the convergence processor to the packet network and telephone network interfaces regarding handling of the telephone calls to and from the user terminals.

8. The apparatus according to claim 7, wherein the softswitch is adapted to communicate with the packet network and telephone network interfaces by transmitting and receiving at least one of Session Initiation Protocol (SIP) or and SIP for telephones (SIP-T) packets.

9. The apparatus according to claim 1, wherein the convergence processor is adapted to receive registration requests from the user terminals and, in response to the registration requests, to register the user terminals in a home location register (HLR) in the telephone network.

10. The apparatus according to claim 9, wherein the convergence processor is adapted to communicate with the HLR in order to determine respective service profiles applicable to the user terminals.

11. The apparatus according to claim 10, wherein the convergence processor is adapted, responsively to the service profile, to invoke an Intelligent Network (IN) service in the telephone network that is to be applied to a call.

12. The apparatus according to claim 10, wherein the convergence processor is adapted to determine the respective service profiles initially upon registration of the user terminals and to update one or more of the service profiles thereafter while the user terminals are in operation.

13. The apparatus according to claim 10, wherein the convergence processor is adapted to receive from the packet network interface an indication of a request from one of the user terminals to set up a call, and responsively to the indication, to cause the telephone network interface to route the call to a telephone number in the telephone network in accordance with an applicable service profile.

14. The apparatus according to claim 9, wherein the convergence processor is adapted to receive a request from the HLR for routing information with respect to a call placed from the telephone network to a telephone number that is assigned to a user terminal having a network address in the packet network and, responsively to the request, to cause the packet network interface to route the call to the network address of the user terminal.

15. The apparatus according to claim 9, wherein the convergence processor is adapted to communicate with the HLR using a Mobile Application Protocol (MAP).

16. A method for communication, comprising:
coupling a convergence processor between a packet switch in a packet network and a node in a circuit-switched telephone network;
assigning telephone numbers in the circuit-switched telephone network to user terminals in the packet network; and
connecting telephone calls, using the assigned telephone numbers, between telephones in the circuit-switched network and the user terminals, by operating the convergence processor so as to emulate a mobile switching center (MSC) and a visitor location register (VLR) of the assigned numbers in the circuit-switched telephone network.

17. The method according to claim 16, wherein the packet network comprises an Internet Protocol (IP) network, and wherein the telephone network comprises a cellular telephone network.

18. The method according to claim 17, assigning the telephone numbers comprises assigning different, first and second telephone numbers to a given user terminal in the packet network, wherein the first telephone number belongs to the cellular telephone network, and the second telephone number belongs to a public switched telephone network (PSTN).

19. The method according to claim 16, wherein assigning the telephone numbers comprises assigning to the user terminals telephone numbers having a first country code, while the user terminals are located in a country having a different, second country code.

20. The method according to claim 16, wherein connecting the telephone calls comprises performing Network Address Translation (NAT) so as to connect the calls to the user terminals via the packet network.

21. The method according to claim 16, wherein connecting the telephone calls comprises converting media and signaling messages between protocols used respectively in the packet and telephone networks.

22. The method according to claim 16, wherein connecting the telephone calls comprises receiving registration requests from the user terminals and, in response to the registration requests, registering the user terminals in a home location register (HLR) in the telephone network.

23. The method according to claim 22, wherein registering the user terminals comprises communicating with the HLR in order to determine respective service profiles applicable to the user terminals.

24. The method according to claim 23, wherein connecting the telephone calls comprises invoking, responsively to the service profile, an Intelligent Network (IN) service in the telephone network that is to be applied to a call.

25. The method according to claim 23, wherein communicating with the HLR comprises determining the respective service profiles initially upon registration, and comprising updating one or more of the service profiles thereafter while the user terminals are in operation.

26. The apparatus according to claim 23, wherein connecting the telephone calls comprises receiving from the packet network an indication of a request from one of the user terminals to set up a call, and responsively to the indication, routing the call to a telephone number in the telephone network in accordance with an applicable service profile.

27. The method according to claim 22, wherein connecting the telephone calls comprises receiving a request from the HLR for routing information with respect to a call placed from the telephone network to a telephone number that is assigned to a user terminal having a network address in the packet network and, responsively to the request, routing the call to the network address of the user terminal.

28. The method according to claim 22, wherein registering the user terminals comprises communicating with the HLR using a Mobile Application Protocol (MAP).
